(19) United States
(12) Patent Application Publication
(10) Pub. No.: US 2009/0018961 A1
(43) Pub. Date: Jan. 15, 2009

(54) Customer identification system and method for a personalized merchant rewards program

(75) Inventors: Ryan Seven, La Quinta, CA (US); Stuart Graham, Oceanside, CA (US); Charles Seven, Newport Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: 7G INC.

(21) Appl. No.: 11/953,786

(22) Filed: Dec. 10, 2007

Related U.S. Application Data
(60) Provisional application No. 60/948,937, filed on Jul. 10, 2007.
(60) Provisional application No. 60/948,943, filed on Jul. 10, 2007.
(60) Provisional application No. 60/951,686, filed on Jul. 24, 2007.

(51) Int. Cl. G06Q 30/00; H04L 9/00

(52) U.S. Cl. 705/50; 705/14

(57) ABSTRACT

A closed loop loyalty, recognition and rewards program for merchants. Each merchant decides upon their own rewards criteria and similar or analogous identification systems are used to identify customers who are loyal customers of several merchants in a community. This works in conjunction with a system for identifying a customer's product based upon equity accumulation, the system having a memory and a remote processor. The consumer is issued for example, a chip in one embodiment which is RFID enabled and when the consumer enters the business their data comes up on the screen and loyalty programs that are customized for that merchant based upon the frequency of visits by the consumer, may be accessed. The two criteria for rewards are based upon number of visits and a timeframe specified by the merchant, likewise the system is designed so the merchants can communicate with their consumers and invite them to special events or make them aware of special offers. Based upon the data for each customer the system recommends other merchants that a consumer would like to be associated with, and have VIP treatment from and this is an additional services which are offered for consideration.

### RELATED APPLICATION

This application claims the benefit of and priority to U.S. Provisional Application Ser. Nos. 60/948,937, filed Jul. 10, 2007; 60/948,943, filed Jul. 10, 2007; and 60,951,686 filed Jul. 24, 2007, the contents of each of which are incorporated by reference herein in its entirety.

### BACKGROUND

Portable fob technology implementing RFIDs (such as that found in Exxon/Mobil's Speedpass®) uses transponders that activate when presented to a Point of Sale (POS) device. The fob's identification data is simply associated with a customer's credit or debit account. The RFID fob may be activated irrespective of whether the user desires such activation, thereby resulting in the initiation and completion of an unwanted transaction including misuse. The portable RFID fob technology is not responsive to or interactive with the customer in connection with personal preferences of the customer, including services and products acquired by or offered to the customer.

The present disclosure relates generally to a reward and/or merchant rewards program, and more particularly, to an improved customer identification system and method for a personalized merchant rewards program.

### SUMMARY

A system for identifying a customer's favorite product based upon a equity value accumulation merchant rewards program or related systems. In one embodiment, the system has a memory and a remote processor. The memory for storing at least customer account information, the at least customer account information comprising a customer's name, an account equity value, and a customer's list of favorite products acquired from a plurality of merchants participating in the merchant rewards program. The remote processor configured to receive a customer identification code and a merchant identification code from a merchant processor, the customer identification code is associated with the customer account, the merchant identification code is associated with one of a plurality of merchants participating in the merchant rewards program, and to determine a merchant's eligibility for accessing the customer account, and transmit the customer's name and the list of favorite products to the participating merchant for display. The customer identification code may be a radio frequency identification (RFID) signal.

According to a feature of the present disclosure, an improved closed loop loyalty, recognition and rewards program driven by at least a system for identifying a customer's products including an equity-based accumulation, the system comprising a memory for storing at least customer account information, the at least customer account information comprising a customer's name, an equity value, and a list of products acquired from a plurality of merchants participating in merchant rewards type of program, and at least a processor configured to receive a customer identification code and a merchant identification code from a merchant processor, the customer identification code is associated with the customer account, the merchant identification code is associated with one of a plurality of merchants participating in the merchant rewards program, determining a merchant's eligibility for accessing the customer account, and to transmit the customer's name and the list of favorite products to the participating merchant for display.

According to a feature of the present disclosure, a method for identifying a customer's favorite product based upon a equity value accumulation merchant rewards program is disclosed. The method includes at a merchant location, providing an interrogation signal from a radio frequency identification (RFID) reader, receiving an RFID signal from a customer's radio frequency transmitter, the RFID signal associated with a customer's account data, transmitting the RFID signal and a merchant identification information to a remote server, at the remote server location, determining the merchant's eligibility for accessing the customer's account data, and transmitting the customer's account data to the merchant for display, wherein the customer's account data comprises a customer's name and a list of favorite products acquired from a plurality of merchants participating in the merchant rewards program.

The method may further include at the merchant location, activating the customer's radio frequency transmitter in response to the interrogation signal, encrypting an authentication code using the customer's radio frequency transmitter, receiving the authentication code and the RFID signal from the customer's radio frequency transmitter, and decrypting the authentication code for comparison with an RFID reader authentication code.

The method may further include, a remote processor which may credit the customer's account data with a credit value for providing a review of a product acquired at the merchant location. The remote processor may also credit the customer's account data with a credit value based upon a transaction consummated at the merchant location. The remote processor may also update the list of favorite products based upon a transaction consummated at the merchant location.

According to a feature of the present disclosure, a method for identifying a customer's favorite product based upon a equity value accumulation merchant rewards program, the method comprising at least a merchant location, providing an interrogation signal from a radio frequency identification (RFID) reader, receiving an RFID signal from a customer's radio frequency transmitter, the RFID signal associated with a customer's account data transmitting the RFID signal and a merchant identification information to a remote server at the remote server location, determining the merchant's eligibility for accessing the customer's account data; and transmitting the customer's account data to the merchant for display, wherein the customer's account data comprises a customer's name and a list of favorite products acquired from a plurality of merchants participating in the merchant rewards program.

According to a feature of the present disclosure, a customer identification system, at a merchant location, for implementation with a equity value accumulation merchant rewards program, the system comprising, a display unit, a radio frequency identification (RFID) reader configured to provide an interrogation signal for activating a customer's radio frequency transmitter and to receive an RFID signal from the customer's radio frequency transmitter, the RFID signal being associated with a customer's account data, the customer account data comprising a customer's name, an account equity value, and a customer's list of favorite products acquired from a plurality of merchants participating in the merchant rewards program, and a merchant processor in communication with the RFID reader and the display unit, the merchant processor transmits the RFID signal to a remote processor, and receives back the customer's name and the list of favorite products for display on the display unit.

According to a feature of the present disclosure, a kit comprising at least one Flavor Dot® brand or type of device housing an RFID tag and instructions for use, which may be an electronic link.

### DRAWINGS

The above-mentioned features and objects of the present disclosure will become more apparent with reference to the following description taken in conjunction with the accompanying drawings wherein like reference numerals denote like elements and in which:

FIG. 1 is an exemplary block diagram of an improved customer identification system for a personalized merchant rewards program, according to one embodiment of the present invention.

FIG. 2 is an exemplary block diagram of a merchant rewards server in communication with a customer and a plurality of participating merchants, according to one embodiment of the present invention.

FIG. 3 is an exemplary flow chart representing a method for providing a customer with participating merchants' information and customer's account information, according to one embodiment of the present invention.

FIG. 4 is an exemplary flowchart representing a method for providing a merchant participating in the merchant rewards program with customer information and customer favorites at the merchant location, according to one embodiment of the present invention.

FIG. 5 is an exemplary flowchart outlining the operation of the merchant rewards server for identifying and transmitting customer information and customer favorites to a participating merchant, according to one embodiment of the present invention.

FIG. 6 is an exemplary flowchart outlining the operation of the merchant rewards server for crediting customer's account with a credit value based upon a transaction consummated at the merchant location and/or based upon a review of a product acquired at the merchant location, according to one embodiment of the present invention.

### DETAILED DESCRIPTION

Reference will now be made to a preferred embodiment, examples of which are illustrated in the accompanying drawings. While the invention will be described in conjunction with the preferred embodiments, it will be understood that these embodiments are not intended to limit the scope of the invention. On the contrary, the invention is intended to cover alternatives, modifications, and equivalents, which may be included within the spirit and scope of the invention as defined by the appended claims. As such, the description of the embodiments that follow are for purposes of illustration and not limitation.

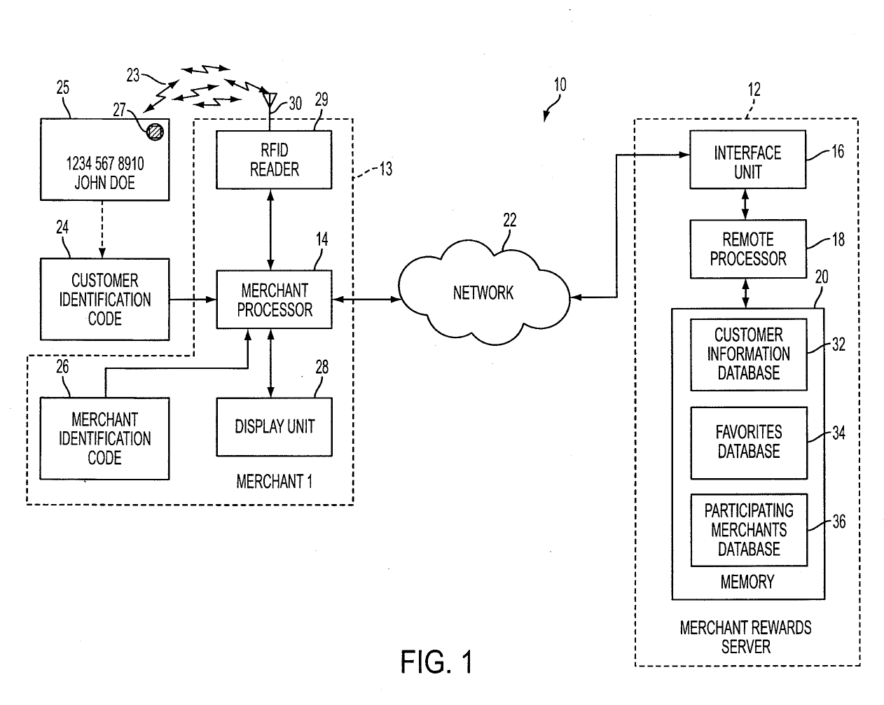

FIG. 1 is an exemplary block diagram of an improved customer identification system 10 for a personalized merchant rewards program, according to one embodiment of the present invention. The merchant rewards program may be tailored as a loyalty benefit for a user, customer and/or merchant. The system 10 may include a merchant rewards server 12 in communication with a merchant processor 14.

At a merchant location 13, the merchant processor 14 may receive a customer identification code 24 and a merchant identification code 26 from one or more data storage devices (not shown), and may transmit the identification codes 24 and 26 to the merchant rewards server 12 for retrieving customer account information. The customer identification code 24 may be associated with the customer account, while the merchant identification code 26 may be associated with one of a plurality of merchants participating in the merchant rewards program.

The merchant rewards server 12 may include an interface unit 16, a remote processor 18 and a memory 20. In one embodiment, the interface unit 16 couples the merchant processor 14 to the remote processor 18. The interface unit 16 couples the merchant rewards server 12 to the merchant processor 14 via a network 22, such as, the Internet, WAN, LAN, or any combinations thereof. The interface unit 16 may incorporate switching mechanisms that controls the transfer of data to the merchant processor 14. According to one embodiment, the interface unit 16 may be adapted to conditionally interface with the merchant processor 14. As such, the interface unit 16 may be configured to determine whether or not one or more predetermined conditions have been met, and thereby controls switching mechanism for providing conditional interface. For example, predetermined conditions for interfacing may include, but not limited to, whether a merchant is eligible to access a customer account information, or whether the customer inquired upon has a customer account with the merchant rewards program. The interface unit 16 may be configured to transmit a rejection code back to the merchant processor 14 if the participating merchant 13 is not eligible to access the customer account. The interface unit 16 may also be configured to transmit a rejection code if the customer identification code 24 is not associated with a merchant rewards customer account.

The memory 20 of the merchant rewards server 12 may be used to store at least customer account information. The customer account information may include a customer's name, an account equity value, and a customer's list of favorite products acquired from a plurality of merchants participating in the merchant rewards program. The account equity value may be a cash value account or a loyalty points account that can be used towards products or services that is of value to the customer. According to one embodiment, the memory 20 may include a customer information database 32, a favorites database 34 and a participating merchants database 36. The customer information database 32 may include customer account information associated with customer identification code 24. The favorites database 32 may include a list of favorite products acquired from a plurality of participating merchants and associated with the customer identification code 24. The participating merchants database 36 may include participating merchant account information, such as but not limited to, merchant identification code 26, merchant location, menu items or list of products sold by merchant, and reviews of merchant products.

The remote processor 18 may be configured to receive the customer identification code 24 and the merchant identification code 26 from the merchant processor 14, determine a merchant's eligibility for accessing the customer account, and transmit the customer's name and the list of favorite products from memory 20 to the participating merchant for display on display unit 28. In one embodiment, the remote processor 18 may be configured to credit the customer account with a credit value for providing a review of at least a product acquired from the participating merchant 13. The remote processor 18 may also be configured to credit the customer account with a credit value based upon a transaction consummated at the participating merchant 13. The remote processor 18 may increment the account equity value by an amount corresponding to the credit value.

As can be envisioned by a person skilled in the art, the remote server may be further configured to update the list of favorite products based upon a transaction consummated at the participating merchant 13. The list of favorite products transmitted to the participating merchant 13 for display are restricted to a predetermined geographical region relative to the participating merchant's location 13.

In one embodiment, the improved customer identification system 10 includes an RFID reader 29 with antenna 30 at the merchant location 13. The RFID reader 29 may be configured to provide an interrogation signal for activating a customer's radio frequency transmitter 27 and to receive an RFID signal 23 from the customer's radio frequency transmitter 27. The RFID signal 23 may include a customer identification code 24 or may be directly associated with a customer's account data. The customer's radio frequency transmitter 27 may be a small chip mounted on a card, such as a merchant rewards card 25, or inserted in a fob (not shown). In one embodiment, the RFID reader 29 may be located in close proximity to the entrance of the merchant store so as to detect and receive a customer's RFID signal 23 upon the customer's entry into the store.

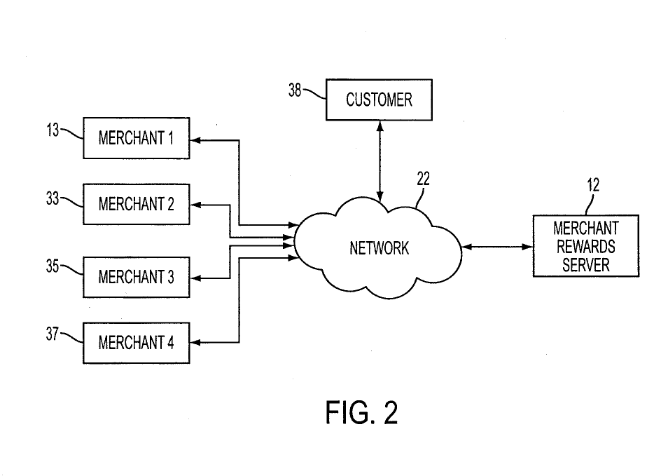

FIG. 2 is an exemplary block diagram of the merchant rewards server 12 in communication with a customer 38 and a plurality of participating merchants 13, 32, 34 and 36, according to one embodiment of the present invention. The merchant rewards server 12 may be coupled via the network 22 to the respective merchant processor 14 for every participating merchant 13, 33, 35 and 37. A customer 38 may access the merchant rewards server 12 via the network 22. For example, customer 38 may access the merchant rewards server 12 by logging onto a merchant rewards website on the internet and search for a participating merchant with specified criteria, such as, a restaurant with a piano bar having salmon on the menu and located within 5 miles from the customer. Such filtering search and customer access to the merchant rewards server 12 is discussed further below.

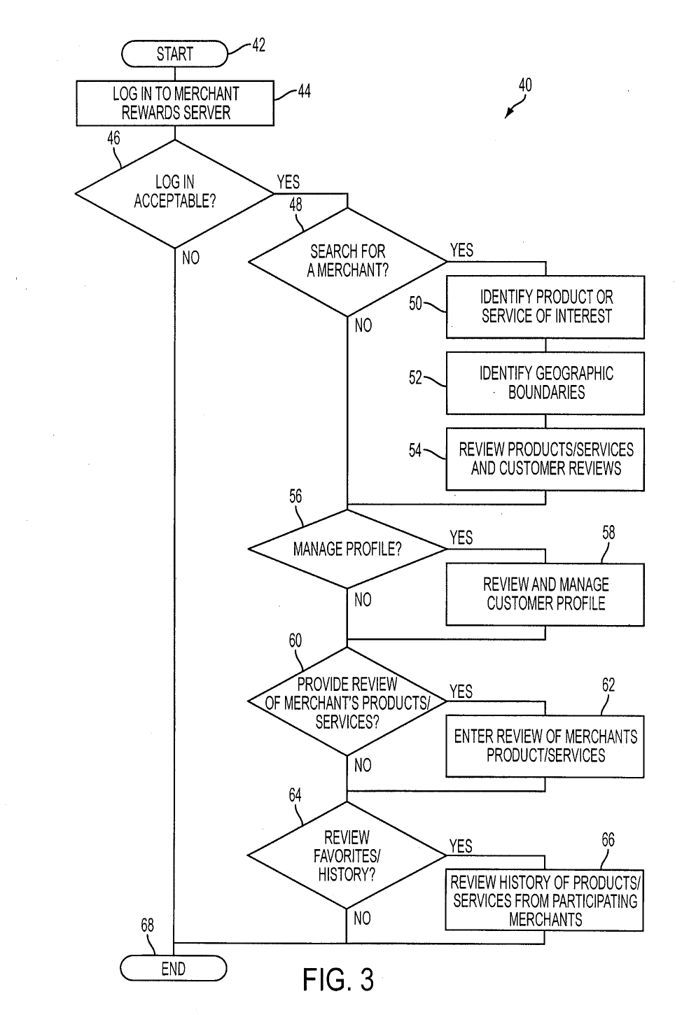

FIG. 3 is an exemplary flow chart representing a method 40 for providing customer 38 with participating merchants' information and customer's account information, according to one embodiment of the present invention. The method begins (42) when customer 38 logs-in to the merchant rewards server 12 (44). For example, the customer 38 may access the merchant rewards server 12 via a merchant rewards website on the internet. The interface unit 16 may be configured to determine if the log-in information is correct (46). If log-in information is correct, the customer may be prompted to select from a variety of features or options on the webpage, including but not limited to, search for a merchant (48), manage profile (56), provide review of merchant's product's/services (60), and review favorites/history (64).

If the customer 38 chooses to search for a participating merchant (48), the customer 38 may be prompted to select one or more search criteria. For example, the search criteria may include, but not limited to, products/services of interest and geographic boundaries/location. In one embodiment, the customer 38 identifies the product/service of interest (50) and identifies the geographic boundaries (52). The customer 38 may then review the search results for the products/services offered by participating merchants and customer reviews for the products/services/merchants (54).

If the customer 38 chooses to manage profile (56), the customer 38 may be granted access to the customer's account, where the customer 38 may review and manage the customer's profile (58). If the customer 38 chooses to provide a review of a merchant's product/service (60), the customer 38 may be required to enter a merchant identification code 26 or select a merchant from the participating merchants database 36, and then enter a review of merchant's products/services (62). In one embodiment, the customer's account is credited with a credit value for providing a review of at least a product/service acquired from the participating merchant. If the customer selects to review favorites/history (64), the customer 38 may be directed to a webpage to review a acquire history log or the list of favorite products/services acquired from one or more merchants participating in the merchant rewards program (66). The method 40 for providing customer 38 with participating merchants' information and customer's account information ends (68) when customer 38 logs-out or if log-in information was incorrect or invalid.

As can be envisioned by a person skilled in the art, other features or options can be added and/or substituted to the merchant rewards website coupled to the merchant rewards server 12. For example, the website may offer unique combination of features and/or benefits for restaurants and their customers 38. Customers 38 may search by menu items or cuisine. Customers 38 may promote their favorite restaurant and create a fan club. The website may be designed to be interactive and encourage customer participation.

In one embodiment, the website may cater to “Foodies,” an internet group of dining influencers who spend their time talking and writing about food and restaurants. The website may provide Foodies with an opportunity to have their blogs viewed by a wider audience and to encourage them to send their updates to the website when they update their blogs.

The website may provide a venue designed to promote restaurants. Customers 38 may experience restaurants on the website by viewing the restaurant's menu, photos of each menu item (or signature dishes), slide shows, and/or video. The website may be designed to promote restaurants by displaying the personality and/or food of participating merchants 13, 33, 35, and 37 through multimedia known to a person skilled in the art.

Acquiring the multimedia from restaurants is made possible due to the wide proliferation of digital cameras and the ease of use restaurants will encounter when they update their profile with the multimedia. One advantage of using the merchant rewards website is the ability to search through participating merchant's menu. For example, if a customer 38 is looking for a Came Asada taco, the customer 38 will be able to pull up all restaurants who serve Came Asada tacos (assuming the restaurant has uploaded the menu on the merchant rewards server 12). This provides a huge incentive for restaurants to upload their menu.

In one embodiment, the merchant rewards website may include a Geo Coding Interface between the website and Google Earth for mapping and directions. The website may be configured to determine the customer's location based on the customer's IP address and automatically searches through the participating merchants database 36 to identify restaurants within a predetermined distance from the customer's location. In another embodiment, the website may be configured to identify the customer's IP address and automatically present a map from Google Earth of the customer's location. The customer 38 may then search for a menu item or cuisine to determine restaurants within a predetermined distance from the customer's location that serve the desired dish.

According to an embodiment of the invention, the website may be configured to provide live filtering. For example, if a customer 38 chooses calamari, the website will display the search results, which can be further filtered, for example, to restaurants suitable for a business meeting, which can be further filtered, for example, to a restaurant with a piano bar. The filtering may be live and dynamic, providing automatic update to the filtering search engine.

In addition to the filtering search engine, the website may offer reviews, both professional and those written by fans. In one embodiment, the website may display photographs and pricing of items on a participating merchant's menu, including reviews related to the menu items. The website may be configured as restaurant centric as opposed to community or directory centric.

In one embodiment, the merchant rewards website may be configured to determine the customer's preferences and tastes through the customer's interaction with the website. For example, based on the customer's history log of search criteria, the website recommends not only restaurants within a predetermined distance from the customer 38, but also recommend specific dishes on a participating merchant's menu to the customer 38.

The website may further be configured to include a message center where customers 38 can communicate with their favorite restaurant(s) and receive special offers. This helps customers from being inundated with emails and allows participating merchants 13, 33, 35 and 37 to check messages at their convenience. Restaurants may promote and highlight a Thanks Gift Certificate on the website. In one embodiment, participating merchants will have the opportunity to market full value gift certificates online, allow for online reservations and payment for take out orders online.

As can be envisioned by a person skilled in the art, various embodiments may be implemented to the website for providing useful services and resources to participating merchants. For example, the website may be configured to offer credit card processing and any other service where there is a demand for in the industry. In one embodiment, the website may be configured to engage with the customer 38 to better determine the customer's personal taste, accurately anticipates what the customer 38 likes and dislikes and becomes fully capable of recommending alternatives, restaurants or menu items based upon personal preferences, ratings, and/or acquire history. The website may be further configured to help the customer 38 find new places/participating merchants to visit/dine when the customer is traveling. The website may also be configured to provide savings and special offers sent to the customer's e-mail inbox based upon the customer's favorites. The website may track all of the customer's favorite restaurants and foods in any and every city across the country. Furthermore, the website may be used to take the customer 38 behind the scene to reveal the best dining choices and save the customer 38 valuable time and money. Gaining deeper customer 38 insight is a key to building and sustaining a competitive edge in the restaurant industry.

The merchant rewards website may be used as a destination website whereby customers 38 are provided with a unique platform and community that enables them to interact with and experience restaurants they have never been to before and to connect them to their favorite restaurants in a fun, convenient, and non-obtrusive way. The merchant rewards website may be used as a dynamic marketing platform for participating merchants 13, 33, 35, and 37 that powerfully connects them to their loyal customers 38, provides increased exposure through cost-effective tools and services drives traffic, new customers 38, into their establishment/restaurant; and assists owners and managers in transforming strangers to customers 38 and builds loyalty.

In one embodiment, the merchant rewards website may utilize Adobe Flex 2 to create personalized, multimedia-rich applications that dramatically enhance user experience, revolutionizing the way people interact with the web. As is known by a person skilled in the art, Flex technology is a powerful tool for creating and delivering Rich Internet Applications (RIAs) within the enterprise and across the web.

The website may be configured to operate on any platform, PC or Mac and any browser. The website may be designed to create richer, more usable application interface with a customized look and feel, benefiting participating merchants 13, 33, 35, and 37, customers 38 and marketing partners. In one embodiment, the website may include interactive charts and graphs that enable rich data dashboards and interactive data analysis. The website may provide high performance data connectivity with existing server-side data and advanced business logic to support intelligent search functionality. Furthermore, the website may provide for real-time data push and pull of permission based personal messaging and to enable collaborative applications.

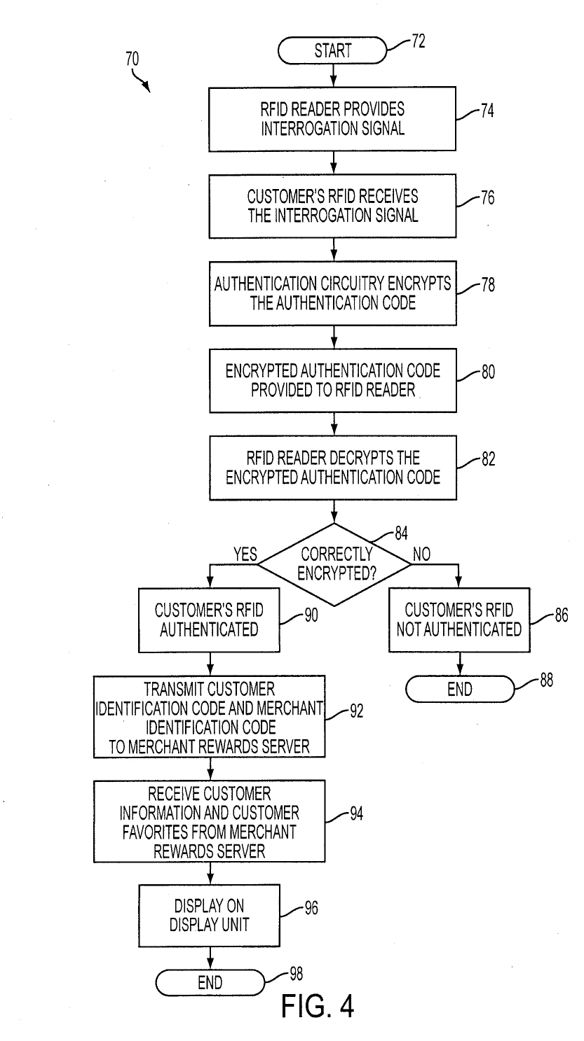

FIG. 4 is an exemplary flowchart 70 representing a method for providing a participating merchant with customer information and customer favorites at the merchant location 13, according to one embodiment of the present invention. In general, the method begins (72) when the customer's radio frequency transmitter 27 is within range for interrogation by RFID reader 29. The RFID reader 29 may provide an interrogation signal to the customer's radio frequency transmitter 27 (74). The interrogation signal may include a random code generated by the RFID reader 29 and encrypted using an encryption key. In one embodiment, the interrogation signal may include an authentication code and/or customer identification code 24. The customer's radio frequency transmitter 27 receives the interrogation signal (76). The interrogation signal may be a request for authentication of the customer's radio frequency transmitter 27. The authentication code is forwarded to an authentication circuitry (not shown) on the merchant rewards card 25. The authentication circuitry encrypts the authentication code (78) and provides to customer's radio frequency transmitter 27 the authentication code for transmission to the RFID reader 29 (80).

The RFID reader 29 may then receive the encrypted authentication code and decrypts it (82). Once the authentication code is decrypted, the decrypted authentication code is compared to the authentication code provided by the RFID reader 29 to verify its authenticity (84). If the decrypted authentication code is not readable or does not match, the customer's radio frequency transmitter 27 is not authenticated (86) and the operation is terminated (88). If the decrypted authentication code is recognizable and matches, the customer's radio frequency transmitter 27 is authenticated (90) and initiates merchant processor 14 to transfer customer identification code 24 to the merchant rewards server 12 (92). The merchant processor 14 subsequently receives customer information and customer favorites from the merchant rewards server 12 (94). The customer information and customer favorites are then displayed on the display unit 28 (96) and the method ends at step 98.

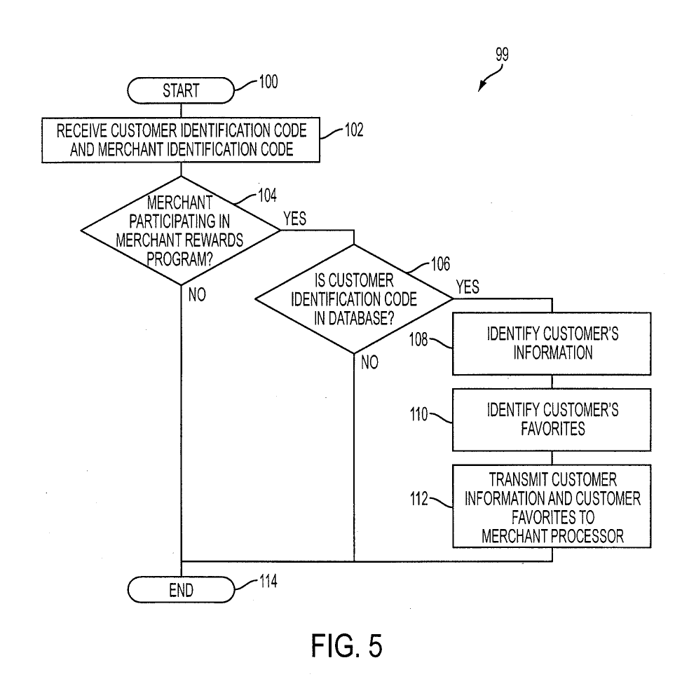

FIG. 5 is an exemplary flowchart 99 outlining the operation of the merchant rewards server 12 for identifying and transmitting customer information and customer favorites to a participating merchant 13, according to one embodiment of the present invention. The operation begins (100) when the merchant rewards server 12 receives customer identification code 24 and merchant identification code 26 (102). The merchant rewards server 12 may compare the merchant identification code 26 with data stored in the participating merchants database 36 (104). If the merchant identification code 26 is recognizable and matches, the merchant rewards server 12 may compare the customer identification code 24 with data stored in the customer information database 32 (106). If the customer identification code 24 is recognizable and matches, the merchant rewards server 12 identifies the customer's information from the customer information database 32 (108) and the customer's favorites from the favorites database 34 (110). The merchant rewards server 12 may then transmit the customer's information, such as name and address, and the customer's favorites to the merchant processor 14 (112). If the merchant identification code 26 and the customer identification code 24 does not match with data stored in memory 20, the operation is terminated (114).

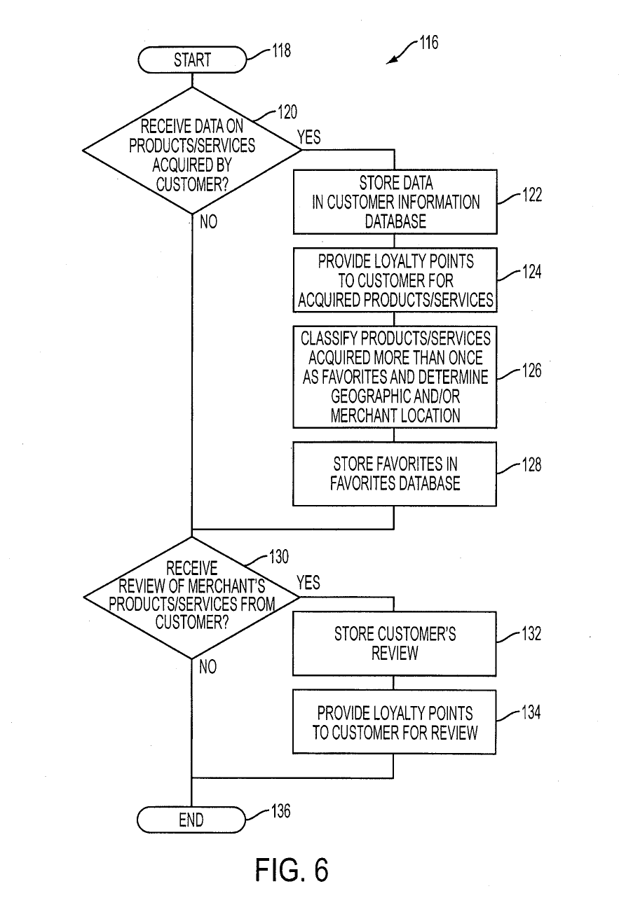

FIG. 6 is an exemplary flowchart 116 outlining the operation of the merchant rewards server 12 for crediting customer's account with a credit value based upon a transaction consummated at the merchant location 13 and/or based upon a review of a product/service acquired at the merchant location 13, according to one embodiment of the present invention. The operation begins (118) when the merchant rewards server 12 determines if it received data on products/services acquired by the customer 38 at the merchant location 13 (120). If the merchant rewards server 12 receives data on products/services acquired by the customer 38, the data may be stored in the customer information database 32 (122). The merchant rewards server 12 may be configured to credit the customer account with a credit value (i.e. loyalty points) based upon a transaction consummated at the participating merchant 13 (124). The remote processor 18 of the merchant rewards server 12 may increment the account equity value by an amount corresponding to the credit value. The merchant rewards server 12 may also be configured to classify the products/services acquired more than once as favorites and may further categorize based on geographic and/or merchant location 13 (126). The merchant rewards server 12 may update the favorites database 34 accordingly (128).

If the merchant rewards server 12 receives a review from the customer 38 of a merchant's products/services (130), the review information may be stored in the customer information database 32, participating merchants database 36 and/or any other memory location (132). The merchant rewards server 12 may be configured to credit the customer account with a credit value (i.e. loyalty points) for providing a review of at least a product acquired from the participating merchant 13 (134). The remote processor 18 of the merchant rewards server 12 may increment the account equity value by an amount corresponding to the credit value. The operation ends if the merchant rewards server 12 does not receive data on products/services acquired by the customer 38 at the merchant location 13 nor does it receive a review of a product/service acquired at the merchant location 13 (136).

As can be envisioned by a person skilled in the art, the invention may be implemented with a loyalty program based on recognition. For example, the invention may be tied to the frequency of visits (i.e. if customer visits 3 times, he will get a free drink). This helps track the customers, providing recognition based on their loyalty to the restaurant or store.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. For example, any combination which performs a functionally analogous task as merchant rewards server 12 is understood within the scope of the specification to be included within the definition of the server. Likewise, artisans understand that for the purpose of the instant disclosure, the server 12 may include any number of serially linked units performing these functions within the scope of this invention.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such items should be interpreted in their most expansive forms so as to afford the applicant the broadest coverage legally permissible.

1. An improved closed loop loyalty, recognition and rewards program driven by at least a system for identifying a customer's products including an equity-based accumulation, the system comprising, in combination:
a memory for storing at least customer account information, the at least customer account information comprising a customer's name, an equity value, and a list of products acquired from a plurality of merchants participating in merchant rewards type of program; and
at least a processor configured to:
receive a customer identification code and a merchant identification code from a merchant processor, the customer identification code is associated with the customer account, the merchant identification code is associated with one of a plurality of merchants participating in the merchant rewards program,
determine a merchant's eligibility for accessing the customer account, and
transmit the customer's name and the list of favorite products to the participating merchant for display.

2. The system of claim 1, wherein the processor is further configured to credit the customer account with value for providing a review of at least a product acquired from the participating merchant.

3. The system of claim 1, wherein the processor is remote.

4. The system of claim 1, wherein the processor is further configured to credit the customer account with a equity-based value based upon a transaction consummated at the participating merchant.

5. The system of claim 4, wherein the processor is further configured to increment the account equity by an amount corresponding to a credit.

6. The system of claim 1, wherein the processor is further configured to update the list of products based upon a transaction consummated at a designated merchant.

7. The system of claim 1, wherein the list of products transmitted to the participating merchant for display are restricted to a predetermined geographical region relative to the designated merchant's location.

8. The system of claim 5, wherein the customer identification code is a radio frequency identification (RFID) signal.

9. The system of claim 1, wherein the processor is further configured to determine if the customer identification code is associated with a merchant rewards customer account.

10. A method for identifying a customer's favorite product based upon a equity value accumulation merchant rewards program, the method comprising:
at a merchant location, providing an interrogation signal from a radio frequency identification (RFID) reader;
receiving an RFID signal from a customer's radio frequency transmitter, the RFID signal associated with a customer's account data;
transmitting the RFID signal and a merchant identification information to a remote server;
at the remote server location, determining the merchant's eligibility for accessing the customer's account data; and
transmitting the customer's account data to the merchant for display,
wherein the customer's account data comprises a customer's name and a list of favorite products acquired from a plurality of merchants participating in the merchant rewards program.

11. The method of claim 10, further comprising crediting the customer's account data with a credit value based upon a transaction consummated at a merchant location.

12. The method of claim 10, further comprising crediting the customer's account data with a credit value for providing a review of a merchant's product acquired at the merchant location.

13. The method of claim 10, further comprising updating the list of favorite products based upon a transaction consummated at the merchant location.

14. The method of claim 10, wherein the list of favorite products transmitted to the merchant for display are restricted to a geographical region comprising the merchant location.

15. The method of claim 10, further comprising providing the customer with a search engine coupled to the remote server to retrieve information on a product sold by one of the plurality of merchants.

16. The method of claim 10, wherein the transmitted customer's account data is independent of how the customer pays for a transaction consummated at the merchant location.

17. The method of claim 10, further comprising:
at the merchant location, activating the customer's radio frequency transmitter in response to the interrogation signal;
encrypting an authentication code using the customer's radio frequency transmitter;
receiving the authentication code and the RFID signal from the customer's radio frequency transmitter; and
decrypting the authentication code for comparison with an RFID reader authentication code.

18. The method of claim 10, further comprising determining if the RFID signal is associated with a merchant rewards account.

19. A customer identification system, at a merchant location, for implementation with a equity value accumulation merchant rewards program, the system comprising:
a display unit;
a radio frequency identification (RFID) reader configured to provide an interrogation signal for activating a customer's radio frequency transmitter and to receive an RFID signal from the customer's radio frequency transmitter, the RFID signal being associated with a customer's account data, the customer account data comprising a customer's name, an account equity value, and a customer's list of favorite products acquired from a plurality of merchants participating in the merchant rewards program; and
a merchant processor in communication with the RFID reader and the display unit, the merchant processor transmits the RFID signal to a remote processor, and receives back the customer's name and the list of favorite products for display on the display unit.

20. A kit, comprising at least one Flavor Dot® brand or type of device housing an RFID tag and instructions for use, which may be an electronic link.
